(19) United States
(12) Patent Application Publication
(10) Pub. No.: US 2024/0174483 A1
(43) Pub. Date: May 30, 2024

(54) METHOD FOR PLACING A CALL FOR AN ELEVATOR SYSTEM

(71) Applicant: Inventio AG, Hergiswil (CH)

(72) Inventors: Christian Studer, Kriens (CH); Martin Kusserow, Luzern (CH); Qixuan Zhang, Thalwil (CH)

(21) Appl. No.: 18/551,891

(22) PCT Filed: Mar. 29, 2022
(86) PCT No.: PCT/EP2022/058263

§ 371 Date: Sep. 22, 2023

(30) Foreign Application Priority Data
Mar. 31, 2021 (EP) 21166371.1

(51) Int. Cl. B66B 1/46; B66B 1/34

(52) U.S. Cl. CPC B66B 1/468; B66B 1/3461; B66B 2201/4615; B66B 2201/4638; B66B 2201/4653

(57) ABSTRACT

A method for placing a call for an elevator system, the elevator system including a mobile communication device carried by a user of the elevator system, a beacon that emits a beacon signal, and a controller of the elevator system, wherein the method includes the steps of: capturing the beacon signal by the mobile communication device; recognizing a gesture of the user by the mobile communication device; identifying an intention of the user to use the elevator system, wherein the recognized gesture and the captured beacon signal are used for this purpose; displaying a user interface on the mobile communication device for sending an elevator call; and sending the call to the controller.

### FIELD

The present invention relates to a method for placing a call for an elevator system by means of a mobile communication device which is carried by a user of the elevator system.

### BACKGROUND

Such methods are known in the prior art.

For example, U.S. Pat. No. 6,209,685 B1 discloses a method which automatically executes an elevator call using a mobile telephone and using a beacon. However, this can lead to unnecessary elevator calls.

Furthermore, WO 2012/130729 discloses a user guidance within a building using an elevator system having destination call control. The user uses his mobile telephone for the user guidance. The position of the mobile telephone within the building is determined using known technology. However, in order to use the system known from WO 2012/130729, the user must first find the appropriate application on his device and start or activate it. This may be time-consuming.

Furthermore, it is known from the prior art that mobile telephones recognize a Bluetooth signal of a beacon and can also communicate the recognition to the user of the mobile telephone. However, this can lead to unnecessary notifications to the user of the mobile telephone and even be bothersome; if the user's path passes many Bluetooth transmitters or beacons, but the user does not intend to use one of these services, this leads to many disruptive notifications to the user. Such notifications can, for example, be visual notifications on the screen, audible notification such as a beep, or also a vibration of the mobile telephone.

### SUMMARY

An object of the present invention is to specify a method for calling an elevator that is user-friendly and as reliable as possible.

According to the invention, this object is achieved by a method having the features described as follows.

According to the invention, it is identified whether the user intends to use the elevator system. If this is identified, a user interface for sending a call for an elevator of the elevator system is displayed to the user.

The identification of whether the user wishes to use the elevator system takes place by recognizing a gesture. A gesture is in general a typical use of the mobile communication device and is well known from the operating systems for mobile communication devices such as iOS and Android. Furthermore, the beacon signal of the beacon of the elevator system is captured. Using the captured beacon signal and the recognized gesture, it is identified whether the user intends to use the elevator system or not. If an intention is to use the elevator system is identified, a user interface is displayed on the mobile communication device for sending a call, and a possible input of the call to the control of the elevator system is transmitted.

In this case, the call can be a conventional floor call, but also what is known as a destination call, as is described, for example, in WO 2012/130729 and also in U.S. Pat. No. 6,209,685 B1.

In this case, a gesture which indicates an intended call input can be:
removing the mobile communication device from a pocket, such as a pants pocket, jacket pocket, shoulder bag, briefcase, or the like,
activating the screen of the mobile communication device,
unlocking the screen or a keyboard of the mobile communication device,
looking at the screen of the mobile communication device,
shaking the mobile communication device,
moving the mobile communication device into a position that is typical for making an input, and/or
an input via a button or push-button, switch and/or keyboard, or a touch-sensitive screen.

According to a preferred embodiment, at least one of the following sensors of the mobile communication device is used to recognize the gesture:
an acceleration sensor, by means of which a movement of the device can be identified,
a gyroscope, by means of which a change in orientation of the device can be identified,
a brightness sensor which can identify a change in the brightness of the ambient light,
a camera, by means of which it is possible to identify whether a user of the device is looking at its screen for displaying the user interface,
a distance sensor for determining a distance to another object,
a compass,
a push-button,
a touch-sensitive screen, or
a capacitive switch.

According to a preferred embodiment, a time profile of a signal strength of the beacon signal is used when identifying the intention of the user to use the elevator system.

By means of this embodiment, in addition to the current use of the mobile communication device by the user, which is recognized by a gesture, a position of the user is also used, absolutely and/or relative to the beacon, when identifying the intention of the user. This enables a particularly reliable identification of the user's intention.

According to a preferred embodiment, a current signal strength of the beacon signal is used when identifying the intention of the user to use the elevator system.

By means of this embodiment, in addition to the current use of the mobile communication device by the user, which is recognized by a gesture, a profile of the position of the user is also used, absolutely and/or relative to the beacon, when identifying the intention of the user. This enables a particularly reliable identification of the user's intention.

Further advantages, features, and details of the invention can be found in the following description of embodiments and with reference to the drawings, in which like or functionally like elements are provided with identical reference signs.

### DESCRIPTION OF THE DRAWINGS

The drawings are merely schematic and not true-to-scale.

FIG. 1 shows an access region to an elevator system.

FIG. 2 shows an elevator system.

FIG. 3 shows, purely schematically, a method for operating an elevator system.

### DETAILED DESCRIPTION

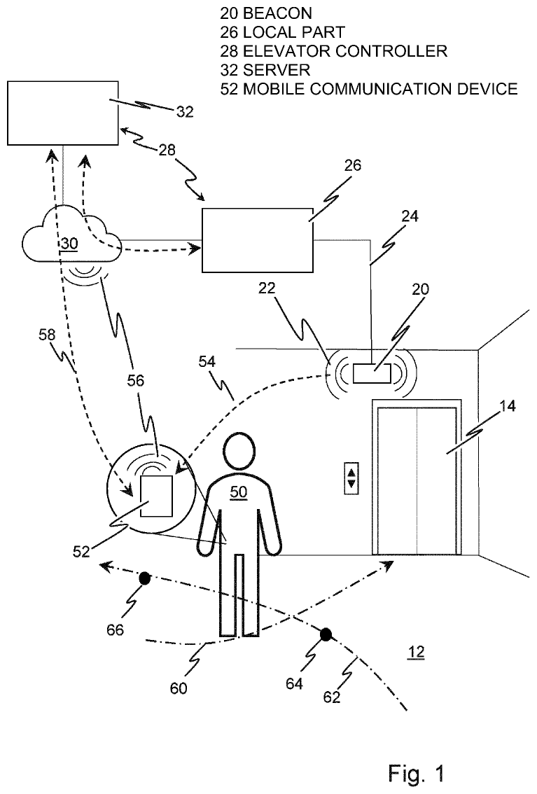

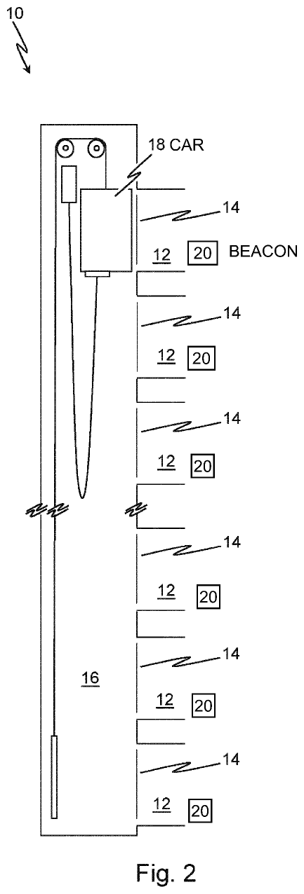

FIG. 1 shows an access region 12 to an elevator system 10 shown in FIG. 2. FIG. 1 shows a shaft door 14 of the elevator system 10.

A beacon 20 is arranged in the access region 12 formed around the shaft door 14. In this embodiment, this is designed as a Bluetooth Low Energy beacon and emits a beacon signal 22.

As shown in FIG. 1, the beacon 20 can be connected via a data connection 24 to a local part 26 of an elevator controller 28 in order to exchange data with the elevator controller 28. The elevator controller can also be referred to for short as the controller. However, this data connection 24 can also be dispensed with. The local part 26 of the elevator controller 28 is further connected to a server 32 of the elevator controller 28 via a data network 30 such as the Internet or a local network. The server 32 is designed to receive and process a call from a mobile communication device 52 and to provide a call command or travel command to the local part 26 of the elevator controller 28. The server 32 is also part of the elevator controller 28. In this case, the server 32 can also communicate with several local elevator controllers of other elevator systems, not shown in FIG. 1. In other words, the server 32 can be assigned several local elevator systems.

FIG. 1 further shows a user 50 who is carrying a mobile communication device 52. The mobile communication device 52 can be a mobile telephone, for example. This is designed to receive the beacon signal 22. This is shown in FIG. 1 by the arrow 54 shown by a broken line. Furthermore, the mobile communication device 52 is designed to communicate with the elevator controller 28 via a data connection 58, in order to place a call to the elevator system 10, i.e., to trigger a destination call, for example. The data connection 58 typically takes place via a signal 56 of an at least partially wireless data network, such as via a mobile data network of a telephone provider such as 3G, 5G, or LTE. Other wireless data networks such as Wi-Fi or Bluetooth are also possible. The data connection 58 can also be achieved in part via an electrically-conductive cable or optical waveguide, as is customary in data communication networks.

In FIG. 1, two possible paths 60, 62 of a possible user 50 of the elevator system 10 are also shown. On the first path 60, the user 50 approaches the shaft door 14 of the elevator system 10. It is consequently to be assumed that the user 50 intends to use the elevator system. On the other path—the path 62—the user 50 appears not to want to use the elevator system 10, since the path 62 leads past the shaft door 14 in an arc. An object of the present invention is to specify a method which indicates to the user 50 a call input mask on his communication device 52, and indicates to him thereby that he can input a call via his communication device 52. In contrast, the user 50 is, as far as possible, not to be disturbed on his path 62 past the elevator system 10.

According to the invention, this object is achieved by the fact that the mobile communication device 52 of the user 50 recognizes a typical gesture which indicates that the user wishes to use the elevator system 10 and wishes to make a call input via his mobile communication device 52. Consequently, according to the invention, it is first recognized whether the user 50 performs a gesture which is typical if the user wishes to place a call to the elevator controller. If no such gesture is performed, the method is aborted. Furthermore, the beacon signal 22 is also used in this case.

If a gesture has been recognized, the gesture is evaluated as to whether there is an intention of the user to use the elevator system 10. If the intention of the user has been identified, to the effect that the user wishes to use the elevator system, and if the mobile communication device 52 captures the beacon signal 22, the mobile communication device 52 displays a call input mask for the elevator system 10 to the user.

In this case, a gesture which indicates an intended call input can be:
removing the mobile communication device 52 from a pocket, such as a pants pocket, jacket pocket, shoulder bag, briefcase, or the like,
activating the screen of the mobile communication device 52,
unlocking the screen or a keyboard of the mobile communication device 52,
looking at the screen of the mobile communication device 52,
shaking the mobile communication device 52,
moving the mobile communication device 52 into a position that is typical for making an input, and/or
an input via a button or push-button, switch and/or keyboard, or a touch-sensitive screen.

A keyboard can be designed, for example, mechanically or also on a touch-sensitive screen, and a button, a push-button, or a switch can also be designed both mechanically and so as to be touch-sensitive—for example, by means of a corresponding display on a touch-sensitive screen. A touch-sensitive screen can also recognize a gesture, such as a specific figure or pattern, without there being a special display for this purpose.

If either no gesture is recognized which indicates an intended call input, or the beacon signal 22 is not received, the mobile communication device 52 does not perform any further action with regard to the placing of a call; in particular, no call input mask is displayed.

If the call input mask is displayed, the user can input a call via the call input mask. This is sent by the mobile communication device 52 to the elevator controller 28 of the elevator system 10.

For the recognition of the gesture, the mobile communication device can use one or more of the following sensors:
an acceleration sensor, by means of which a movement of the device can be identified,
a gyroscope, by means of which an orientation and/or a change in orientation of the device can be identified,
a brightness sensor which can identify a change in the brightness of the ambient light;
for example, an infrared sensor can be used for this purpose,
a camera, by means of which it is possible to identify whether a user of the device is looking at its screen for displaying the user interface,
a distance sensor for determining a distance to another object,
a compass, in order to determine, for example, an orientation of the mobile communication device 52 with respect to the shaft door 14,
a push-button for identifying, for example, pressing of a push-button or pressure switch,
a capacitive switch, or
a touch-sensitive screen.

It can also prove advantageous for the beacon signal 22 to also be used in addition to the gesture, when an intention of the user to use of the elevator system is being identified.

For example, the beacon signal can be evaluated with respect to the absolute signal strength. For example, for the identification of the intention to use the elevator system, the signal strength can be checked to determine whether it exceeds a minimum signal strength. If several signals are received from different beacons, it could also be required that the beacon signal 22 of the elevator system 10 must be the strongest signal. For example, further devices could be installed in the surroundings of the shaft door, which devices also have a beacon and send out a corresponding signal.

Furthermore, the beacon signal 22 could be evaluated with respect to the time profile of the signal strength. For example, the signal strength of the beacon 20 would initially increase on the path 62, but, from a certain point, which is marked with point 64 in FIG. 1, also decrease again. As soon as the beacon signal decreases again, it can be concluded from this that the user 50 does not want to use the elevator system, since he is no longer moving towards the beacon 20. If the user 50, when passing the elevator system 10, e.g., at point 66, takes his mobile communication device 52 into his hand and looks at the screen thereof, this would correctly not be identified as intended use of the elevator system. Display of the user interface for sending a call would not occur.

In contrast, the beacon signal 22 continuously increases on the path 60. It can be concluded from this that the user 50 is moving towards the beacon 20, and consequently towards the elevator system 10, and therefore intends to use the elevator system. If the user 50 takes his mobile communication device 52 into his hand and looks at the screen thereof on the path 60 to the elevator system 10, this would be identified as an intended use of the elevator system. Display of the user interface for sending a call would take place.

In one exemplary embodiment, the beacon 20 transmits at least the following information as the beacon signal 22:
a Uniform Resource Locater, abbreviated as URL, which indicates the network address of the server 32 or its network name,
an identification of the elevator system 10,
an identification of the floor or the shaft door 14.

The identification of the elevator system 10 and/or the floor can also be transmitted as a component of the URL.

In one exemplary embodiment, the mobile communication device 52 can be designed to open the URL, obtained with the beacon signal 54, directly by means of a web browser. The server returns, as a response, a website which displays the user interface—in particular, the graphical user interface for the elevator system 10—on the mobile communication device 52. The user can then enter his call via the mobile communication device 52, and the browser sends the input back to the server.

In an alternative embodiment, the mobile communication device 52 can also use a dedicated application instead of the previously described web browser on the mobile communication device 52 for opening the URL. In this case, for example, the transmission of the data for displaying the user interface, from the server 32 to the mobile communication device 52, could be dispensed with.

In another exemplary embodiment, if a dedicated application is used, the beacon 20 can also send just one identification, such as a Universally Unique Identifier, which is typically abbreviated as UUID.

Further protocols for beacon signals are known to a person skilled in the art and can likewise be used.

FIG. 2 shows the elevator system 10, wherein the components shown in connection with FIG. 1 are not shown for the sake of clarity. The elevator system 10 has a shaft 16 in which a car 18 can travel substantially in the vertical direction between the individual floors which the elevator system 10 serves. The shaft 16 is closed on each floor by the shaft door 14. On each floor, the access region 12 to the elevator system 10 is formed in front of the shaft door 14.

The elevator system 10 shown in FIG. 2 is designed as a traction elevator. Alternatively, the elevator system could be designed as a hydraulic elevator or with cars which are each driven by a linear motor. In an embodiment having a linear motor, the car can typically also move in the horizontal direction. Further types of elevator systems are known to a person skilled in the art and can also be used.

Furthermore, the elevator system can also have several elevator shafts and/or several cars which move in the same elevator shaft. If several cars serve the same floors or common floors and/or have common access regions 12, the control of the elevator system can typically take place by what is known as a group controller.

The elevator system 10 can be equipped with the beacon 20 on each floor. However, it is also conceivable for the beacon 20 to be installed only on selected floors or access regions 12. If no beacon is installed in an access region 12, the elevator can be called in a conventional manner or also in the conventional manner using the mobile communication device 52, as is known from the prior art.

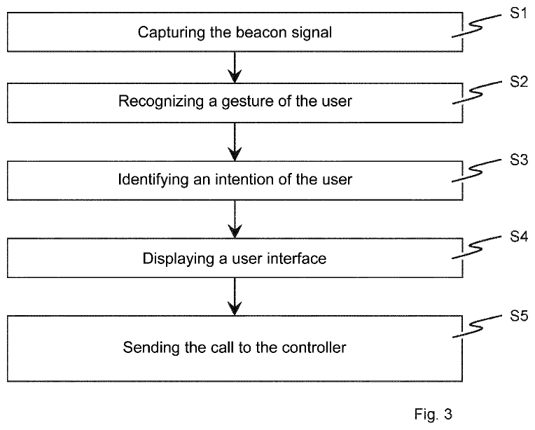

The method already described above for placing a call for an elevator system 10 is shown schematically in FIG. 3 and comprises the following steps:

In a step S1, the beacon signal 22 is captured by the mobile communication device 52.

In a step S2, a gesture of the user 50 is recognized by the mobile communication device 52.

In a step S3, an intention of the user 50 to use the elevator system 10 is identified, wherein the recognized gesture and the captured beacon signal 22 are used for this purpose.

In a step S4, a user interface is displayed on the mobile communication device 52 for sending a call.

In a step S5, the call is sent to the controller 28 of the elevator system 10.

Steps S1 and S2 are shown in succession in FIG. 3. However, step S2 can also take place before step S1, or also, temporally, in parallel with step S1.

In accordance with the provisions of the patent statutes, the present invention has been described in what is considered to represent its preferred embodiment. However, it should be noted that the invention can be practiced otherwise than as specifically illustrated and described without departing from its spirit or scope. claims 1-4. (canceled)

5. A method for placing a call for an elevator system, the elevator system including a mobile communication device carried by a user of the elevator system, a beacon that emits a beacon signal, and a controller of the elevator system, the method comprising the steps of:
capturing the beacon signal by the mobile communication device;
recognizing a gesture of the user by the mobile communication device;
identifying an intention of the user to use the elevator system, wherein the recognized gesture and the captured beacon signal are used to identify the intention;
displaying a user interface on the mobile communication device to enable the user to send a call; and
sending the call to the controller of the elevator system.

6. The method according to claim 5 including using at least one of the following sensors of the mobile communication device to recognize the gesture:
an acceleration sensor by which a movement of the mobile communication device is identified;
a gyroscope by which an orientation and/or a change in orientation of the mobile communication device is identified;
a brightness sensor that identifies a change in a brightness of ambient light;
a camera by which whether the user of the mobile communication device is looking at a screen displaying the user interface is identified;
a distance sensor determining a distance to another object;
a compass;
a push-button;
a touch-sensitive screen; and
a capacitive switch.

7. The method according to claim 5 including using a time profile of a signal strength of the beacon signal to identify the intention of the user to use the elevator system.

8. The method according to claim 5 including using a current signal strength of the beacon signal to identify the intention of the user to use the elevator system.

9. A method for placing a call for use of an elevator system, the elevator system including a beacon that emits a beacon signal and a controller of the elevator system, the method comprising the steps of:
a user carrying a mobile communication device approaching the beacon;
capturing the beacon signal by the mobile communication device;
recognizing a gesture of the user by the mobile communication device;
identifying an intention of the user to use the elevator system, wherein the recognized gesture and the captured beacon signal are used to identify the intention;
displaying a user interface on the mobile communication device to enable the user to send a call; and
the user sending the call to the controller of the elevator system using the mobile communication device.
